(19) United States
(12) Patent Application Publication
(10) Pub. No.: US 2005/0000125 A1
(43) Pub. Date: Jan. 6, 2005

(54) Labeling apparatus and method of making same

(76) Inventors: Christopher A. Pawlik, Malvern, PA (US); David C. Diemer, Collegeville, PA (US); Neil G. Sellars, Cinnaminson, NJ (US)

Correspondence Address: REED SMITH LLP, 2500 ONE LIBERTY PLACE, 1650 MARKET STREET, PHILADELPHIA, PA, 19103, US

(21) Appl. No.: 10/724,025

(22) Filed: Nov. 26, 2003

Related U.S. Application Data
(63) Continuation-in-part of application No. 09/898,871, filed on Jul. 3, 2001, now abandoned.
Application No. 09/898,871 is a continuation of application No. 09/232,121, filed on Jan. 15, 1999, now Pat. No. 6,274,236.
Application No. 09/232,121 is a division of application No. 08/662,842, filed on Jun. 12, 1996, now abandoned.
Application No. 08/662,842 is a continuation-in-part of application No. 08/489,611, filed on Jun. 12, 1995, now abandoned.
(60) Provisional application No. 60/429,668, filed on Nov. 27, 2002.

(51) Int. Cl. G09F 3/10

(52) U.S. Cl. 40/299.01

(57) ABSTRACT

An apparatus for labeling a roll of product, the apparatus including: a first substantially planar member; and, a second substantially planar member releasably adhered to the first planar member in a peelable and resealable fashion; wherein, the first and second substantially planar members are suitable for being partially torn to access a corresponding portion of the product when the apparatus is secured about the roll.

### CROSS-REFERENCE TO RELATED APPLICATIONS

This application claims priority of U.S. Patent Application Ser. No. 60/429,668, entitled LABELING APPARATUS AND METHOD OF MAKING SAME, filed Nov. 27, 2002, and is a continuation-in-part application of U.S. patent application Ser. No. 09/898,871, entitled “LABELS AND METHOD OF MAKING SAME”, filed Jul. 3, 2001, which is a continuation of U.S. patent application Ser. No. 09/232,121, filed Jan. 15, 1999, now U.S. Pat. No. 6,274,236, which is a divisional application of U.S. patent application Ser. No. 08/662,842, filed Jun. 12, 1996, which is a continuation-in-part application of U.S. patent application Ser. No. 08/489,611, filed Jun. 12, 1995, the entire disclosures of each of which are hereby incorporated by reference as if being set forth in their respective entireties herein.

### FIELD OF INVENTION

The present invention relates to labels and, more particularly, to labels of the kinds which may be secured, or otherwise wrapped, about rolls, or other cross-sectional shape, of products, and at least partially destroyed to gain access to the product.

### BACKGROUND OF THE INVENTION

Examples of products that are generally well suited for being packaged in rolls include edible products like rolls of Rolaids® brand antacid tablets or LifeSavers® brand candies, by way of non-limiting example. In practice, such products may be configured for sale in rolls, about which rolls labels according to the present invention may be secured. To access the product, the label may be partially torn, such that a corresponding portion of the product may be removed and the remainder of the label remain secured about the remainder of the roll.

### SUMMARY OF INVENTION

An apparatus for labeling a roll of product, the apparatus including: a first substantially planar member; and, a second substantially planar member releasably adhered to the first planar member in a peelable and resealable fashion; wherein, the first and second substantially planar members are suitable for being partially torn to access a corresponding portion of the product when the apparatus is secured about the roll.

The first member includes first and second oppositely disposed surfaces, the second surface includes at least one adhesive thereon, and the adhesive adheres the second surface to the first surface in a suitable fashion for securing the apparatus about the roll.

A method for making an apparatus for labeling a roll of product, the method including: releasably adhering a first substantially planar member to a second substantially planar member in a peelable and resealable fashion; wherein, the first and second members are adapted to be partially torn to access a corresponding portion of the product in the roll when the apparatus is secured about the roll.

### BRIEF DESCRIPTION OF THE DRAWINGS

Understanding of the present invention will be facilitated by consideration of the following detailed description of the preferred embodiments of the present invention taken in conjunction with the accompanying drawings, in which like numerals refer to like parts, and:

FIG. 1 illustrates a roll of product to be labeled according to an aspect of the present invention;

FIG. 2A illustrates a first plan view of a labeling apparatus according to an aspect of the present invention;

FIG. 2B illustrates a second plan view of the labeling apparatus of FIG. 2A;

FIG. 2C illustrates a side view of the apparatus of FIG. 2A;

FIG. 3A illustrates a first plan view of a first substantially planar member suitable for use with the apparatus of FIGS. 2A and 2B;

FIG. 3B illustrates a second plan view of the substantially planar member of FIG. 3A;

FIG. 4A illustrates a first plan view of a second substantially planar member suitable for use with the apparatus of FIGS. 2A and 2B;

FIG. 4B illustrates a second plan view of the substantially planar member of FIG. 4A; and,

FIG. 5 illustrates a flow diagrammatic view of an exemplary method for making the apparatus of FIGS. 2A and 2B.

### DESCRIPTION OF THE PREFERRED EMBODIMENTS

It is to be understood that the figures and descriptions of the present invention have been simplified to illustrate elements that are relevant for a clear understanding of the present invention, while eliminating, for purposes of clarity, many other elements found in labeling and packaging apparatus, systems and methods. Those of ordinary skill in the art will recognize that other elements are desirable and/or required in order to implement the present invention. However, because such elements are well known in the art, and because they do not facilitate a better understanding of the present invention, a discussion of such elements is not provided herein. The disclosure herein is directed to all such variations and modifications to such apparatus, systems and methods known to those skilled in the art.

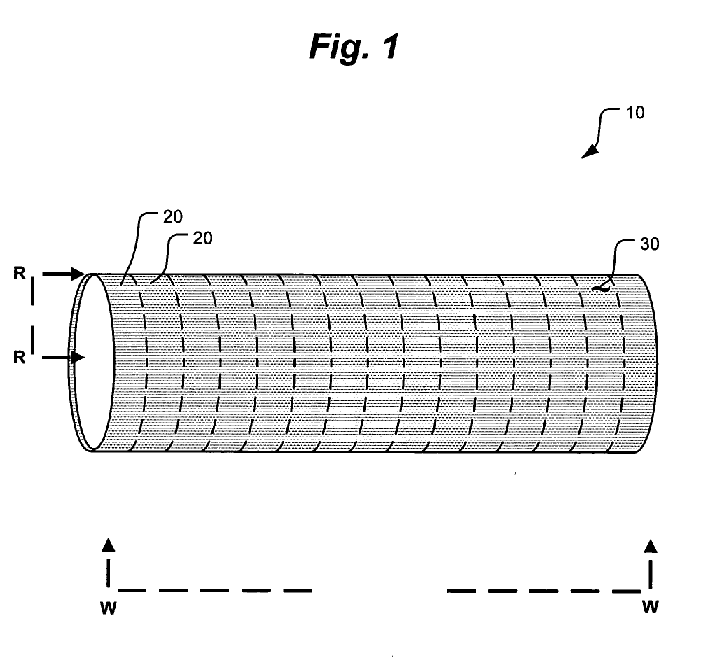

Referring now to FIG. 1, by way of non-limiting example only, there is shown a roll 10 of tablet-like product 20 in a stacked configuration. Product 20 may be provided within an encasing substrate 30, that may be formed of conventional packaging foil, for example. Roll 10 may be generally characterized as having a width (W) and radius (R). As is conventionally understood, where roll 30 substantially forms a cylinder, the surface area of substrate 30 may be approximately the circumferential surface area of the roll, or 2πRW, plus the ending surface areas, or 2πR². Of course, the cross-section of roll 20 may form any suitable polygonal shape (e.g., square or rectangular), curvilinear shape (e.g., circular or oval) or composite polygonal and curvilinear cross-sectional configuration defining a desired perimetrical exterior wall surface to be labeled.

According to an aspect of the present invention, there may be provided a label suitable for being secured about the outer perimetrical surface of a roll of product, and including at least one panel forming one or more pages that may be resealably accessed. The roll of product may, or may not, include an encasing substrate, such as packaging foil.

In general, a resealable label according to an aspect of the present invention may be constructed and arranged such that opening or use of a panel does not render it impossible to reseal the label. A resealable label may generally be restored to substantially its initial appearance and condition after having been opened.

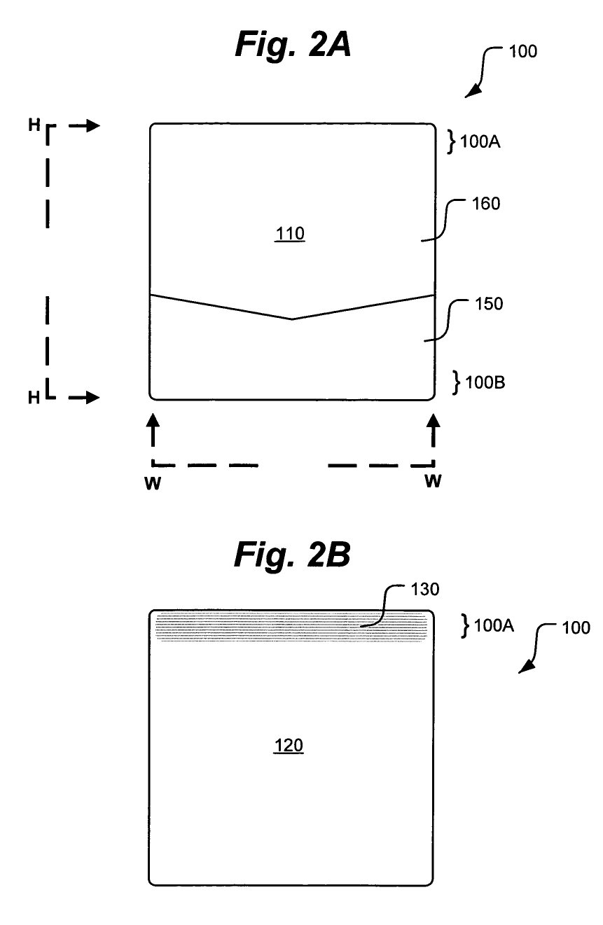

Referring now also to FIGS. 2A, 2B and 2C, there are shown plan views of a labeling apparatus 100 according to an aspect of the present invention. Apparatus 100 includes first and second generally oppositely disposed surfaces 110, 120. Surface 120 may be suitable for being secured about roll 10 in an inwardly facing disposition.

As is shown in FIGS. 2A and 2B, apparatus 100 may generally have a width approximately equal to width W. Apparatus 100 may have a height generally corresponding to the perimetrical circumference (C) of roll 10. Height H may be slightly greater than perimetrical circumference (C), such that when apparatus 10 is secured about roll 10, a portion of apparatus 100 may overlap with another portion of apparatus 10. For example, a portion 100A of apparatus 100 may overlap with a portion 100B of apparatus 100 when secured about roll 10 such that surface 120 of portion 100A adheres to surface 110 of portion 10B. Such adherence of surface 120 to surface 110 may serve to substantially secure apparatus 100 about roll 10. Surface 120 of portion 100A may include an adhesive 130, such as a Pressure Sensitive Adhesive (PSA) by way of non-limiting example, for securing surface 120 to surface 110 in such a manner. Adhesive 130 may be partially deadened.

Apparatus 100 may generally include first and second substantially planar members 150, 160. In operation, member 160 may be releasably adhered to member 150 such that member 160 may be at least partially peeled from member 150 to enable viewing of a greater portion of members 150 and/or 160 than may otherwise be possible, followed by readherence of member 160 to member 150. Surface 110 of apparatus 100 may be formed of a combination of front surfaces of members 150 and 160 collectively. Members 150, 160 may be such that labeling apparatus 10 may be partially destroyed in order to access a corresponding portion of product. In other words, apparatus 100 may be torn, and optionally have a portion thereof removed, to access and remove a corresponding portion of product 20 in a conventional manner.

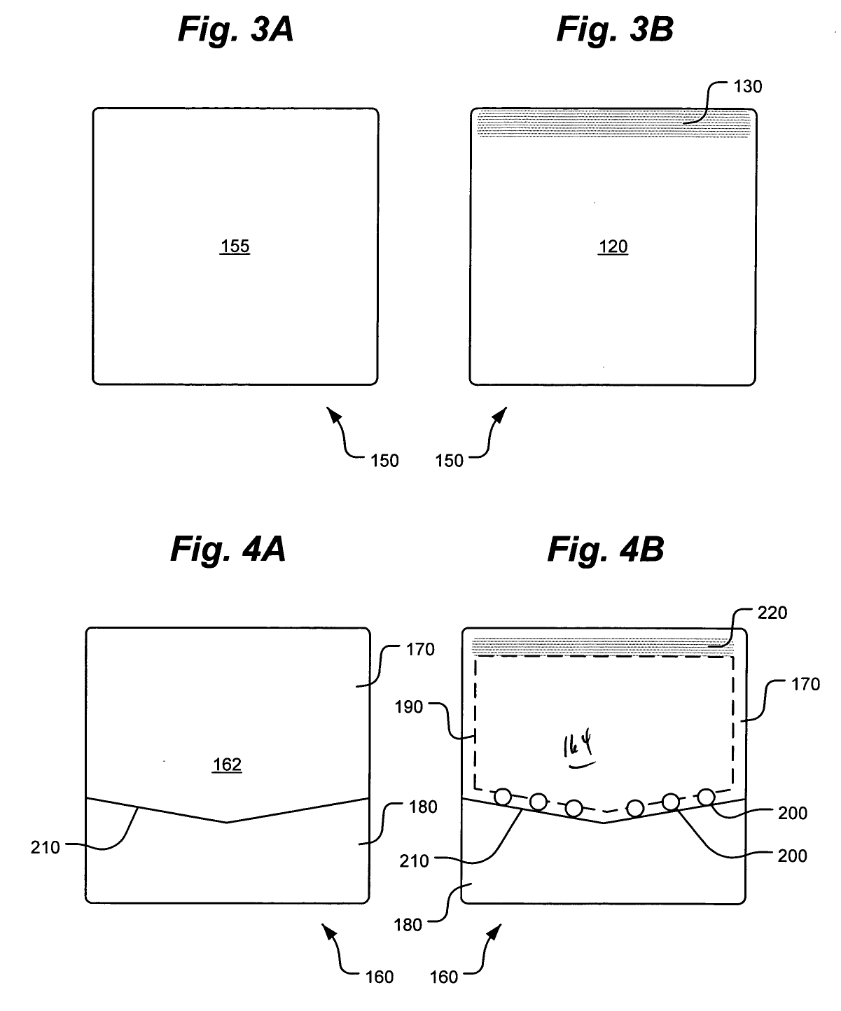

Referring now also to FIGS. 3A and 3B, there are shown plan views of a first substantially planar member suitable for use as member 150 of FIGS. 2A and 2B. As may be seen in FIGS. 3A and 3B, member 150 may be of substantially width W and height H. Member 150 may generally include first and second generally oppositely disposed surfaces 155, 120. Surface 120 of member 150 may form surface 120 of apparatus 100. Surface 155 of member 150 may partially form surface 110 of apparatus 100.

Member 150 may be largely formed of any suitable substrate. For example, member 150 may take the form of a flexible substrate such as a paper or plastic (such as, for example, polyvinyl chloride or polyethylene) sheet or other suitable web material. Member 150 may be clear or tinted, partially or entirely transparent, opaque or translucent, depending upon design criteria. Member 150 may, or may not, include perforations corresponding to positioning of apparatus 100 with respect to product 20, for facilitating partial destruction of member 150 to access product 20.

Referring now also to FIGS. 4A and 4B, there are shown plan views of a second substantially planar member suitable for use as member 160 of FIGS. 2A and 2B. As may be seen in FIGS. 4A and 4B, member 160 may generally have width W and include first and second generally oppositely disposed surfaces 162, 164. Member 160 may include portions 170, 180. Portion 180 may be removed prior to securing apparatus 100 about roll 10, such that members 150 and 160 jointly form surface 110 (see, e.g., FIG. 2C). Accordingly, surface 162 of portion 170 may partially form surface 110 of apparatus 100.

Member 160 may be largely formed of any suitable substrate. For example, member 160 may take the form of a flexible substrate such as a paper or plastic (such as, for example, polyvinyl chloride or polyethylene) sheet or other suitable web material. Member 160 may be clear or tinted, partially or entirely transparent, opaque or translucent, depending upon design criteria. Member 160 may, or may not, include perforations corresponding to positioning of apparatus 100 with respect to product 20, for facilitating partial destruction of member 160 to access product 20.

Surface 164 may have a pressure sensitive adhesive (PSA) 165 disposed on thereon and coupling the substrate to a release liner to better enable processing of the substrate until application of member 160 to member 150. Such adhesive may be partially deadened in a region 190 largely corresponding to portion 170 (region 190 being designated by dashed lines in FIG. 4B). Region 190 may be partially deadened by about 30% or 50%, for example. Such adhesive may be partially deadened in one or more regions 200. Regions 200 are illustrated by way of non-limiting example in FIG. 4B to take the form of circles positioned substantially adjacent to a seam 210 between portions 170 and 180. Regions 200 may be deadened approximately 5%, for example. Such adhesive may be substantially completely deadened everywhere else, except a region 220 positioned and configured for permanently securing member 160 to member 150. Regions 190, 200 and 220 may serve to increase the peel-ability and reseal-ability of members 150 and 160. Although regions 190, 200 and 220 are illustrated to take a particular form, the present invention is not so limited.

Seam 210 may form an outermost edge of member 160 when apparatus 100 is secured about roll 10. Seam 210 is illustrated in the non-limiting example of the Figures to be of a generally triangular shape having an apex near a distance W/2 from either end. Such a triangular shape may improve the peel-ability and reseal-ability of member 160 as compared to a tab for example, due in part to the tearable nature of either member 150 and/or member 160. Of course, seam 210 may take any suitable configuration or shape though.

According to an aspect of the present invention, member 150 may take the form of a 50 lbs. C/2/S substrate having a velocity gloss on surface 155 thereof. Member 150 may take the form of a 50 lbs. or 54 lbs. C/1/S substrate. Member 160 may take the form of 54 lbs. C/1/S substrate, that optionally may include a silicone adhesive. Member 160 may take the form of a 60 lbs. super gloss paper, that optionally may include a silicone adhesive.

Labeling apparatus 100 may include printed indicia on members 150 and/or 160, thereby providing greater billboard areas than may otherwise be available. For example, surface 155 of member 150 may be printed in a conventional manner (e.g. by flexographic, rotogravure, silk screening or other printing methods), thereby providing an amount of billboard commensurate with known techniques for labeling rolls 10 of product. Further, surface 162 of portion 170 may be analogously printed, thereby providing additional billboard. Further yet, surface 164 of portion 170 may be analogously printed providing yet a further degree of billboard. Printing on surface 155 of member 150 obscured by member 160, as well as printing on surface 164 may be viewed upon peeling member 160 from member 150.

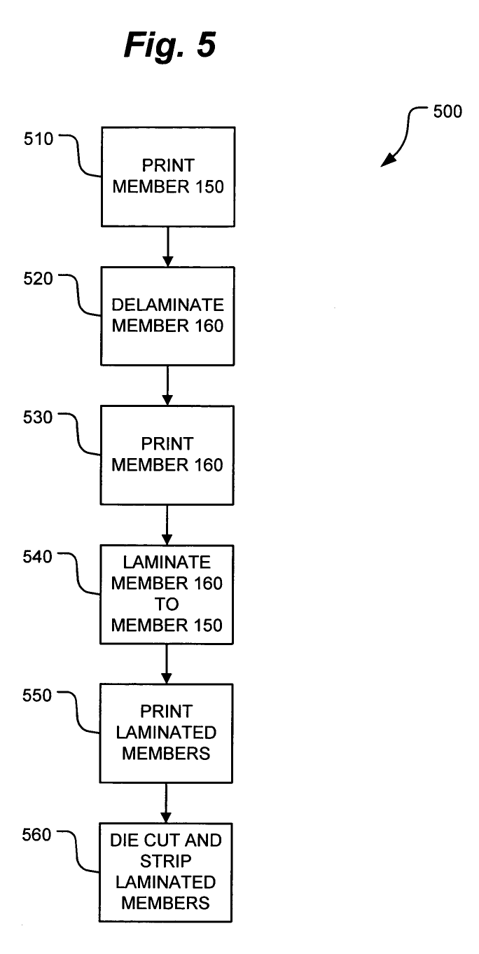

Referring now to FIG. 5, there is shown a block diagrammatic representation of a method 500 suitable for manufacturing apparatus 100.

Member 150 may be printed 510 (e.g. by flexographic, rotogravure, silk screening or other printing methods) on surface 155. In the event that member 150 includes an adhesive on surface 120, such adhesive may optionally be deadened in select areas, such as areas other than areas corresponding to adhesive 130. Otherwise, adhesive 130 may optionally be provided on surface 120.

Where member 160 is provided with an adhesive, such as a pressure sensitive adhesive (PSA), on surface 164, member 160 may be delaminated 520 from a backing layer, or release liner. Member 160 may then be printed 530, on surface 164 of portion 170 for example. Printing 530 may include both printing indicia to be included on apparatus 100 and to provide partial deadening of adhesive on surface 164. For example, regions 190 and 200 may be partially deadened using conventional methodologies and as has been set forth. Further, the remainder of surface 164, excluding region 220, may be substantially completely deadened.

Surface 164 of member 160 may then be laminated 540 to surface 155 of member 150 using conventional methodologies, the adhesive in region 220 and the partially deadened adhesive in regions 190, 200 on surface 164.

Surface 162 of member 160 may then be printed 550. According to an aspect of the present invention, printing on surface 162 may be limited to portion 170, as portion 180 may be removed from the final apparatus 100 using conventional die cutting and stripping 560. Surface 162 may further be varnished.

Die cutting and stripping 560 may include removal of portion 180 as well as trimming of members 150, 160 to the final dimensions desired for apparatus 100. The overall dimensions of members 150 and 160 may be greater than width (W) and height (H) prior to die cutting and stripping 560, to facilitate die cutting and stripping of the bonded members to form apparatus 100 of dimensions W and H in a conventional manner.

According to an aspect of the present invention, adhesive 130 may not be provided until after step 560, although such is not required. For example, an apparatus 100 may be provided for application to a roll 10, such that adhesive 130 is provided on surface 120 substantially contemporaneously with application of apparatus 100 to roll 10 in a conventional manner.

Optionally, perforations may be provided in one or more members 150, 160, to facilitate removal of a portion or all of member 160 and/or a portion or all of member 150. Those skilled in the art will appreciate that the removed member 160 may be or include a coupon, or a pre-printed request for additional information, by way of non-limiting example only.

Although the aforementioned describes preferred embodiments of the invention, the invention is not so restricted. It will be apparent to those skilled in the art that various modifications and variations can be made to the disclosed preferred embodiments of the present invention without departing from the scope or spirit of the invention. Accordingly, it should be understood that the apparatus and method described herein are illustrative only and are not limiting upon the scope of the invention.

1. An apparatus for labeling a roll of product, the apparatus comprising:
a first substantially planar member; and,
a second substantially planar member releasably adhered to the first planar member in a peelable and resealable fashion;
wherein, the first and second substantially planar members are suitable for being partially torn to access a corresponding portion of the product when the apparatus is secured about the roll.

2. The apparatus of claim 1, wherein said roll comprises an encasing substrate.

3. The apparatus of claim 2, wherein said encasing substrate comprises a foil.

4. The apparatus of claim 1, wherein said roll has an initial length, and at least one of said substantially planar members has a width approximate to said initial length.

5. The apparatus of claim 4, wherein said roll has a given perimetrical circumference, and at least one of said substantially planar members has a height approximate said perimetrical circumference of said roll.

6. The apparatus of claim 1, wherein said first and second substantially planar members each comprise first and second surfaces, and at least two of said first surface of said first substantially planar member and first and second surfaces of said second substantially planar member comprise visible indicia.

7. The apparatus of claim 1, wherein at least a portion of said second surface of said first substantially planar member comprises at least one adhesive thereon.

8. The apparatus of claim 7, wherein at least a portion of the adhesive adheres said apparatus about the roll.

9. The apparatus of claim 8, wherein said second substantially planar member is smaller than said first substantially planar member.

10. The apparatus of claim 9, further comprising a second adhesive on at least a portion of said second surface of said second substantially planar member.

11. The apparatus of claim 10, wherein said second adhesive is substantially deadened in an inner portion of said second substantially planar member.

12. The apparatus of claim 11, wherein said second adhesive in an inner portion of said second substantially planar member is deadened about 30%-50%.

13. The apparatus of claim 10, wherein said second substantially planar member comprises an outer edge.

14. The apparatus of claim 13, wherein said second adhesive is partially deadened substantially adjacent to said outer edge of said second planar member.

15. The apparatus of claim 14, wherein said second adhesive is deadened about 5%.

16. A method for making an apparatus for labeling a roll of product, the method comprising:
providing a first substantially planar member;
providing a second substantially planar member; and,
releasably adhering said first substantially planar member to said second substantially planar member in a peelable and resealable fashion;
wherein, the first and second members may be partially torn to access a corresponding portion of the product in the roll when the apparatus is secured about the roll.

17. The method of claim 16, wherein said first and second substantially planar members each comprise first and second surfaces and further comprising printing indicia on at least two of said first and second surfaces.
